(19) United States
(12) Patent Application Publication
(10) Pub. No.: US 2015/0307145 A1
(43) Pub. Date: Oct. 29, 2015

(54) Means and Methods of Subfloor Construction and Integrated Hold Down Systems

(71) Applicant: Steve Weissmann, Sonoma, CA (US)

(72) Inventor: Steve Weissmann, Sonoma, CA (US)

(21) Appl. No.: 14/693,499

(22) Filed: Apr. 22, 2015

Related U.S. Application Data
(60) Provisional application No. 61/983,313, filed on Apr. 23, 2014.

(51) Int. Cl. B62D 63/08; B60P 3/32; B60D 1/48; B62D 21/20; B62D 27/02

(52) U.S. Cl. CPC B62D 63/08; B62D 21/20; B62D 27/023; B60D 1/48; B60P 3/32; B60D 2001/001

(57) ABSTRACT

A trailer system to accommodate the construction and transport of a mobile home or RV comprises a tie down and flooring system to increase the useable vertical space of the attached structure. Two main deck frame members 200 are placed in parallel and are secured together by several Z bar floor joists 400. The lower surfaces of the Z bar floor joists retain a lower pan or galvanized sheet steel plate 300, the steel plate used to protect the undercarriage of the trailer. A tie down assembly comprises several threaded rods attached to the outside vertical surfaces 201 of the two main deck frame members. A sill plate 520 and tie down unit 110 are placed through the threaded rods to provide a low profile tie down system.

### CROSS-REFERENCE TO RELATED APPLICATIONS

This utility patent application incorporates by reference and claims the priority of application 61/983,313 filed on Apr. 23, 2014.

### BACKGROUND OF THE INVENTION

(1) Field of the Invention

The invention generally relates to the construction of small homes built upon trailers. More particularly, the invention relates to means and methods of creating and using integrated subfloor systems and integrated hold down systems within and upon a trailer and related components.

(2) Description of the Related Art

The known related art fails to anticipate or disclose the principles of the present inventions.

In the related art, separate subfloors are often constructed on top of a trailer. Such separate construction methods to construct a subfloor lead to an undesired result of consuming vertical space, in the range of 2 to 4 inches. In the art of mobile homes or tiny homes, strict height limitations are imposed in order to keep the home legal for transport upon public highways. Thus, the prior art of subfloor or sub-assemblies leaves much to be desired. Moreover, the known related art fails to protect the bottom portions of a subfloor during transport.

In some related art embodiments, conventional utility trailers are used that include a wood decking preinstalled upon the trailer. The preinstalled wood decking is in the range of twenty-four inches above the ground. In the related art, RVs are built into the trailer by screwing or bolting into the wood decking.

In the related art, threaded rods, hold down rods, tie downs or hold down assemblies may be found within typical land based constructions. With mobile homes, the prior art has many shortfalls and fails to leverage the position and strength of perimeter metal sometimes found in custom trailers. In the known related art of Tiny House Trailers by Tiny Home Builders, a perimeter flat deck extends past the perimeter metal. The perimeter flat deck of Tiny Home Builders teaches away from the disclosed tie down embodiments, as the flat deck of Tiny Home Builders would not provide adequate attachment points for the disclosed threaded rods, tie downs and tie down assemblies.

### BRIEF SUMMARY OF THE INVENTION

The present invention overcomes shortfalls in the related art by presenting an unobvious and unique combination and configuration of methods and components to integrate subfloor constructions and tie down constructions into trailers configured to accommodate home construction.

### Threaded Rods, Hold Downs, Tie Downs and Related Assemblies

Structural advantages are achieved by welding or otherwise attaching the disclosed threaded rods upon the outer perimeter of a trailer assembly. The disclosed trailer assembly includes perimeter rectangular metal components (sometimes called “main deck frame members”) that are well suited for attachment to tie downs or threaded rods. The use of threaded rods at the outermost perimeter areas of the trailer gives additional sheer value and other structural advantages that would not be achieved if the threaded rods were installed in a more medial or proximal position. The extreme distal or outer position of the tie downs or threaded rods presents structural advantages not found in the known related art.

Further structural advantages are achieved by the artful integration of a trailer fascia board attached over the threaded rods. A plurality of self-tapping screws may be used to secure trailer fascia board to the trailer and threaded rods. The plurality of threaded rods may be secured by welds upon the outside vertical surfaces of the main deck frame members and by frictional attachment provided by the secured fascia boards.

The use of the elongated outside vertical surfaces of the main deck frame members helps to prevent the threaded rods from pivoting or rotating in an outward direction as the elongated outside vertical surfaces of the main deck frame members provide significant surface area for attachment. The fascia boards may include voids to contain the threaded rods. Such fascia board voids may provide structural properties to prevent the threaded rods from moving in a direction parallel to the outer surface of the main deck frame members.

The threaded rods may be further secured by integration with plywood attached to the top of the trailer and a sill plate or second framing member secured upon the top side of the plywood. The plywood may comprise or be replaced with a subfloor. A bolt and washer may further secure the treaded rod to the still plate, subfloor and hold down unit.

### Integrated Subfloor Structures

Disclosed embodiments include means and methods of integrated subfloor construction. In one disclosed embodiment, components of the trailer provide structure and support for a subfloor assembly. The disclosed trailer components include a plurality of joist members or cross members found between the two main deck frame members. The cross members may comprise a “C” channel configuration, or in the best mode known to date, the cross members are in the from a “Z” bar. The Z bars may be referred to as integrated joists or floor joists. The Z bar configuration overcomes shortfalls it the art by providing a maximum amount of surface area to secure foam under the floor and by providing flat top surfaces to accept mechanical attachments in an upward and vertical direction.

Sheet metal or other material may be attached to the bottom portions of the integrated joists. Such lower sheet metal or other material may provide protection to the underside of the trailer and RV. Lower sheet metal may be referred to as a lower pan or galvanized sheet steel plate. Such sheet metal or other material may provide support to insulation. Insulation or other material may be placed within the integrated joists.

### General Attributes

Disclosed embodiments include a trailer specifically designed and fabricated for attaching or erecting a wood build recreational vehicle (RV) or home. Such a RV or home is sometimes called a “tiny house” to the trailer. In one embodiment, a threaded rod is welded or otherwise attached to the trailer and then used as a “hold down” rod in constructing or integrating the RV to the trailer. A flare bevel weld or other means of attachment may be used to secure a threaded rod to the trailer. More specifically, the outside vertical walls of the main deck frame members are exceptionally well suited for attachment to the threaded rods. The relatively low elevation of the outside vertical walls of the main deck frame members assists in maintaining a low profile of the disclosed tie down assembly.

Disclosed trailer systems maximize the useable volume of an RV by eschewing the prior art penchant of using floor framing on top of the chassis or trailer. Disclosed embodiments enable floor framing to be built into the trailer chassis, allowing for greater useable building volume. With RVs, there are strict height limitations, such as 13 feet 6 inches, to avoid collisions with bridges and other road obstacles. The disclosed systems of building floor framing within the confines of the trailer provides tremendous advantages over the prior art as useable RV height is increased in the range of three to four inches. Disclosed trailer systems allow for extra standing room in an RV and/or extra sleeping loft space and/or extra roof pitch. Disclosed trailer systems enable RV construction to comprise homes of classical proportions, a vast improvement over RVs of the related art that are often viewed as short in useable elevation.

In one disclosed embodiment, a trailer comprises two main deck frame members in a parallel configuration and attached to a plurality of Z bar cross members. A front portion of the trailer may comprise a hitching assembly while the back portion may comprise a rear deck frame member and a porch assembly.

These and other objects and advantages will be made apparent when considering the following detailed specification when taken in conjunction with the drawings.

### BRIEF DESCRIPTION OF THE DRAWINGS

FIG. 1 depicts a schematic view of a tie down, threaded rod, hold down or tie down assembly

FIG. 2 depicts a disclosed integrated Z bar floor joist

FIG. 3 depicts a disclosed integrated Z bar floor joist

FIG. 4 depicts a plan view of a disclosed trailer

FIG. 5 depicts a perspective view of a disclosed trailer

FIG. 6 depicts a perspective view of a disclosed trailer with subflooring

FIG. 7 depicts a schematic view of a hold down assembly

FIG. 8 depicts a perspective view of a disclosed trailer with framing positioned upon the decking

FIG. 9 depicts a perspective view of a disclosed trailer with vertical framing members

### REFERENCE NUMERALS IN THE DRAWINGS

100 threaded rod

105 nut, used with threaded rod

110 hold down unit

115 deck screw, such as a stainless steel trim head deck screw

120 fastener, such as a bright basic screw

125 self-tapping screws

200 main deck frame member

201 outside vertical wall section or surface of main deck frame member 200

202 inside vertical wall section or surface of main deck frame member 200

203 tongue and hitch assembly

205 front deck frame member

206 top surface of main deck frame member 200

207 bottom surface of main deck frame member 200

210 leveling jacks

215 wheel well

220 rear deck frame member

225 rear support

300 lower pan or galvanized sheet steel plate

305 lap seal

400 Z bar floor joist

410 vertical section of Z bar floor joist 400

415 upper horizontal section of Z bar floor joist 400

416 inside surface of the upper horizontal section 415 of Z bar floor joist

417 lower horizontal section of Z bar floor joist 400

418 inside surface of lower horizontal section 417 of Z bar floor joist

419 upper or outer surface of upper horizontal section 415 of Z bar floor joist

420 lower or outer surface of lower horizontal section 417 of Z bar floor joist

500 fascia board

505 plywood filler

510 CDX plywood

515 siding, such as 7 inch cedar siding shingles

520 sill plate

525 finished flooring

530 subfloor

535 rigid insulation

540 foam sill seal

545 insulation cut to comport with Z bar

550 porch joist

555 wall stud

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines

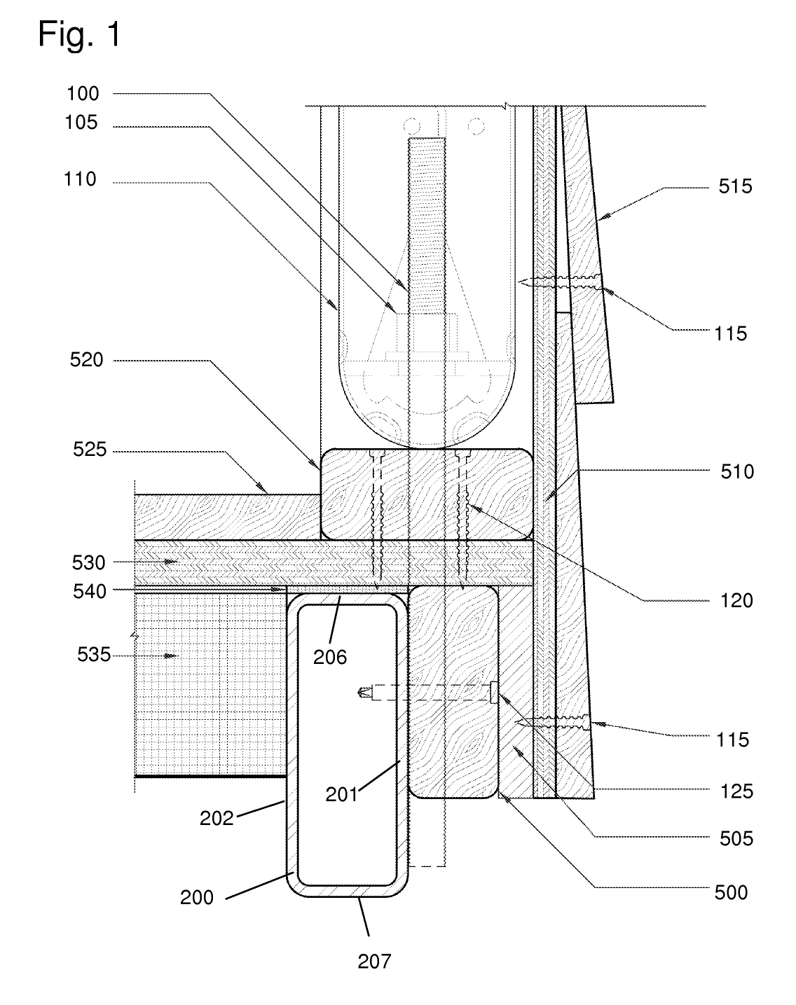

FIG. 1 depicts a disclosed embodiment comprising a threaded rod 100 attached to a main deck frame member 200. Such attachment may be of any means, including a flare bevel weld. The threaded rod 100 is further secured by use of a fascia board 500, the fascia board attached to the main deck frame member 200 by a fastener that may include a self-tapping screw 125. The threaded rod 100 may be secured further by integration with a section of subfloor 530, sill plate 520, hold down unit 110 and nut 105. The hold down unit 105 may be of a standard configuration and may be a Simson Strong Tie HDU4 for side and back walls and HDU5 for front walls.

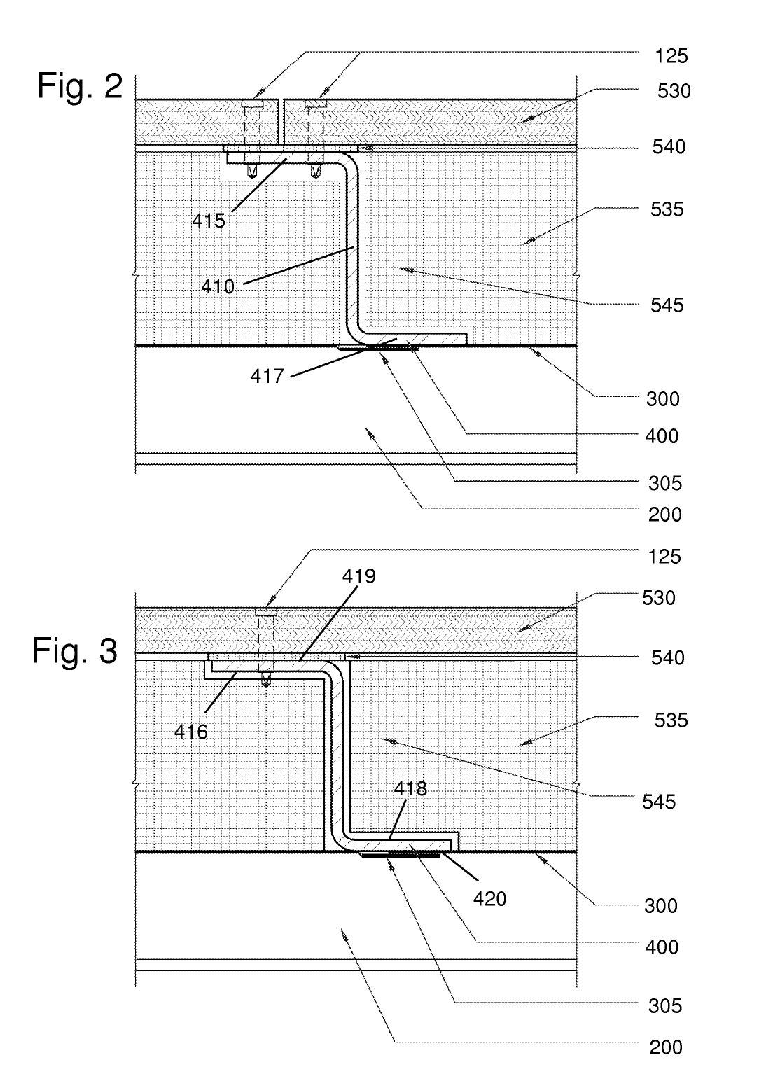

The disclosed configuration of FIG. 1 may further include insulation 535 in the form of rigid insulation secured at, upon or near the main deck frame member. The insulation 535 may be further secured by use of Z bar floor joist as shown below in FIG. 2 and FIG. 3. The main deck frame member 200 is attached to the threaded rod 100, and the threaded rod may be further secured by the fascia board 500, as the fascia board is secured to the main deck frame member by use of a fastener, such as a self-tapping screw 125.

A foam sill seal 540 may be disposed upon the top section of the main deck frame member 200. A subfloor 530 may be disposed upon top surfaces of the deck frame member 200, rigid insulation 535, fascia board 500 and plywood filler 505. A wood sheathing, such as CDX plywood 510 may be fastened to the plywood filer 505, side surface of the subfloor 530 and side surface of the sill plate 520. Finished flooring 525 may be fastened upon the subfloor 530 and adjacent to the sill plate 520. A hold down unit 110 may be secured to the sill plate 520 by use of the threaded rod 100 and a nut 105. A plurality of fasteners 120 may secure the sill plate 520 to the subfloor.

The exterior siding components may comprise a plurality of shingles 515, fastened to the CDX plywood 510. Deck screws 115 or other fasteners may be used to secure the shingles 515 to the CDX plywood 510.

The disclosed configuration of FIG. 1 provides structural support for studs or wall studs, with such studs shown in FIG. 9. The disclosed configuration secures components to the main deck frame members in a manner that lowers the subfloor height and finished floor height to elevations lower than the elevations of the related art. The exterior positioning of the threaded rods 100 takes advantage of the vertical wall 201 sections of the main deck frame members. The related art fails to take advantage of the low elevations of the vertical wall 201 sections of the main deck frame members.

FIG. 2 depicts cross section view of an integrated Z bar floor joist 400. A plurality of integrated joist components may be secured between the two main deck frame members. A disclosed Z bar floor joist 400 may comprise an upper horizontal section 415 attached to a vertical section 410 with the vertical section attached to a lower horizontal section 417. The disclosed Z bar configuration overcomes shortfalls in the related art by providing an upper horizontal section 415 that is suitable to support a foam sill seal 540, one or more subfloor components 530 and the attachment of vertical fasters, such as self-tapping screws 125.

The vertical section 410 of the Z bar overcomes shortfalls in the related art by providing a fastening surface to secure insulation 545 cut to conform to the Z bar 400. The lower horizontal section 417 of the Z bar overcomes shortfalls in the related art by providing an attachment surface for the lower pan 300 or galvanized sheet plate. The lower pan provides protection to the under carriage while the trailer is in transport or while the trailer is stationary. The lower pan also provides support to further retain the insulation within the trailer frame. The lower horizontal section 417 of the Z bar may also support to be attached to lap seals 305, while the majority of the surface area of a lap seal will be disposed upon the lower surface of the lower pan 300. FIG. 1 shows an advantage to the upper horizontal section 415 of the Z bar as the upper horizontal section 415 is shown to support to abutting sections of subfloor and two fasteners 125 to secure the two sections of subfloor

FIG. 3 is a configuration similar to that of FIG. 2, with the exception of the upper horizontal section 415 of Z bar supporting just one section of subfloor 530. FIG. 3 shows the inside surface 416 of an upper horizontal section of Z bar floor joist and the inside surface 418 of the lower horizontal section of Z bar floor joist to be in contact with the insulation.

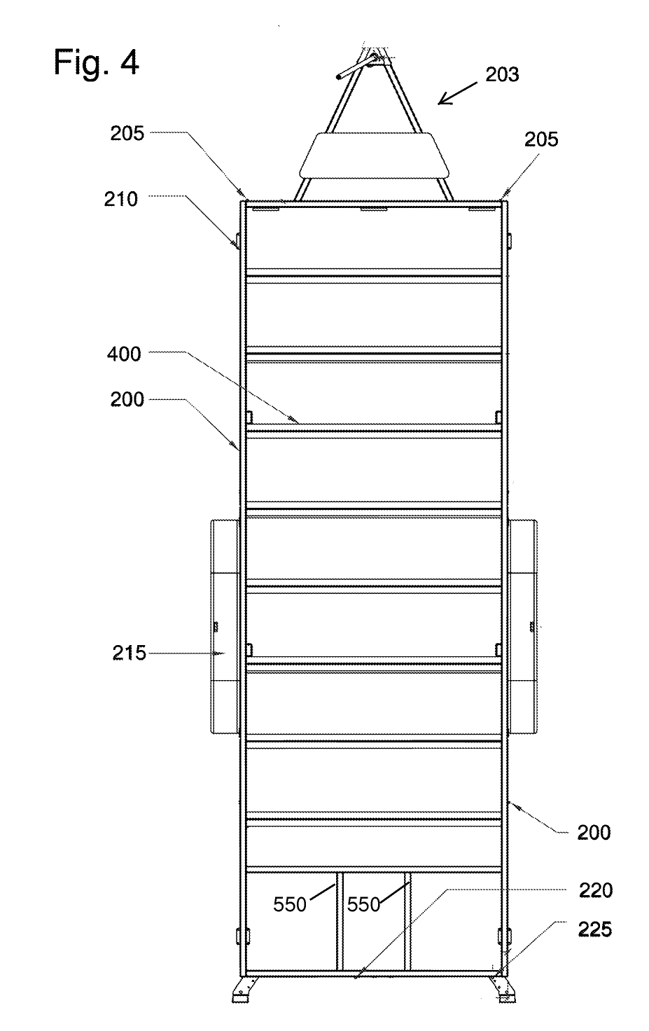

FIG. 4 depicts a plan view of a disclosed trailer, the trailer comprising two parallel main deck frame members 200 secured in position by use of a plurality of integrated Z bar floor joists 400. The two main deck frame members 200 may be further secured by use of a front deck frame member 205 and a rear deck frame member 220. A trailer may comprise a plurality of porch joists 550, being perpendicular or normal to the rear deck frame member 220 and an attached Z bar floor joist 400. The rear deck frame member 220 may be attached to a plurality of rear supports 225. A tongue and hitch assembly 203 may be attached to the front deck frame member 205. Two wheel wells may be attached to the trailer.

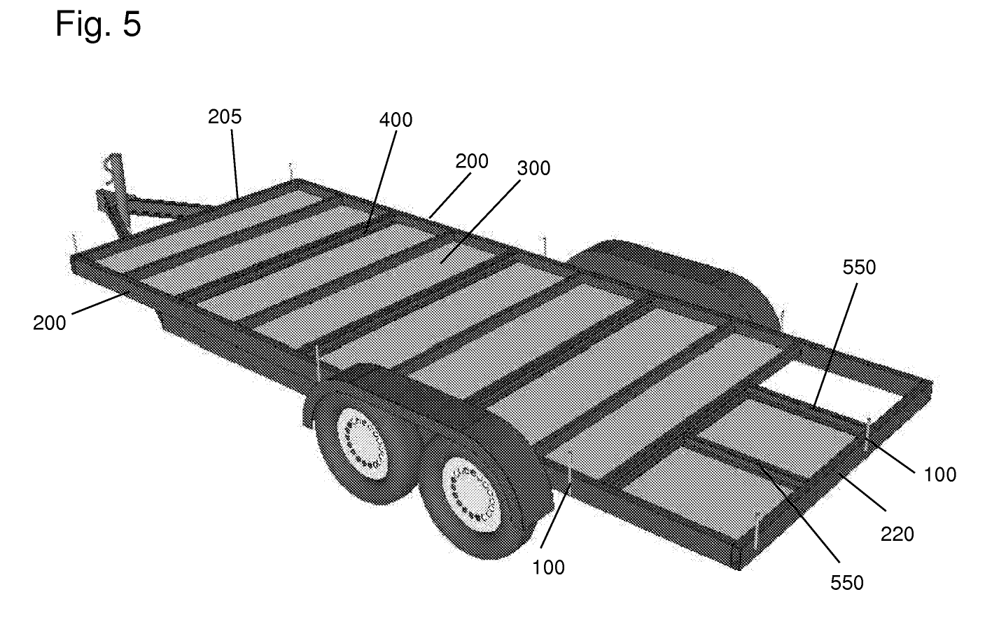

FIG. 5 depicts a perspective view of a trailer comprising two main deck frame members 200 attached to a plurality of Z bar floor joists 400. The bottom horizontal surfaces of the Z bars are attached to a lower pan 300 or galvanized sheet steel plate. A plurality of threaded rods 100 are shown to be attached to the outside vertical surfaces of the two main deck frame members. A front deck frame member is shown in the back ground while a rear deck frame member is shown in the foreground. Two porch joists are shown in attachment to a Z bar floor joist and the rear deck frame member 220.

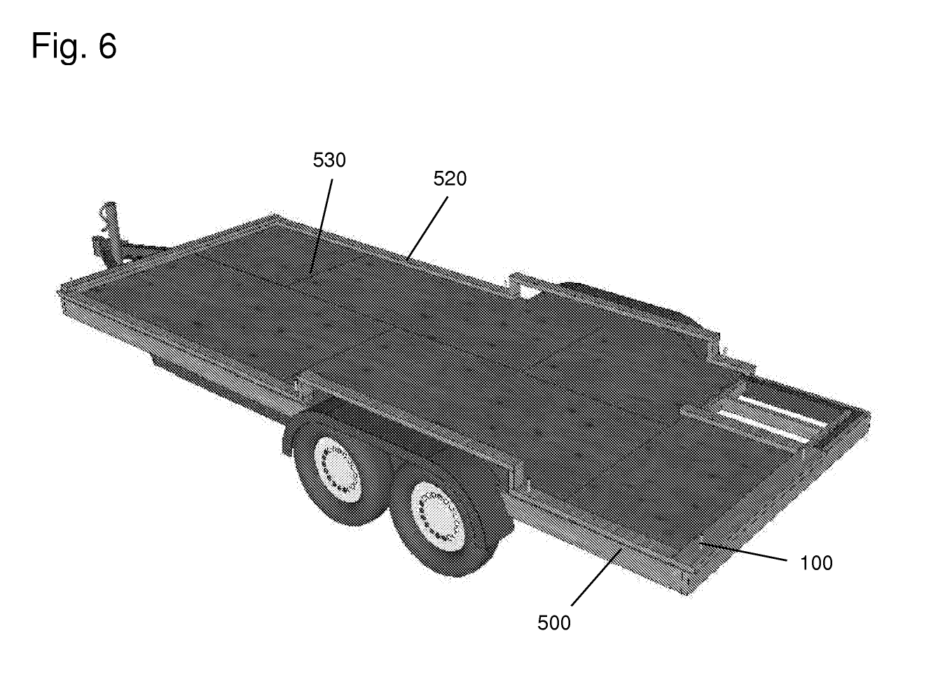

FIG. 6 depicts a perspective view of the trailer of FIG. 5 but with the addition of fascia board 500, sill plate 520 and subfloor 530.

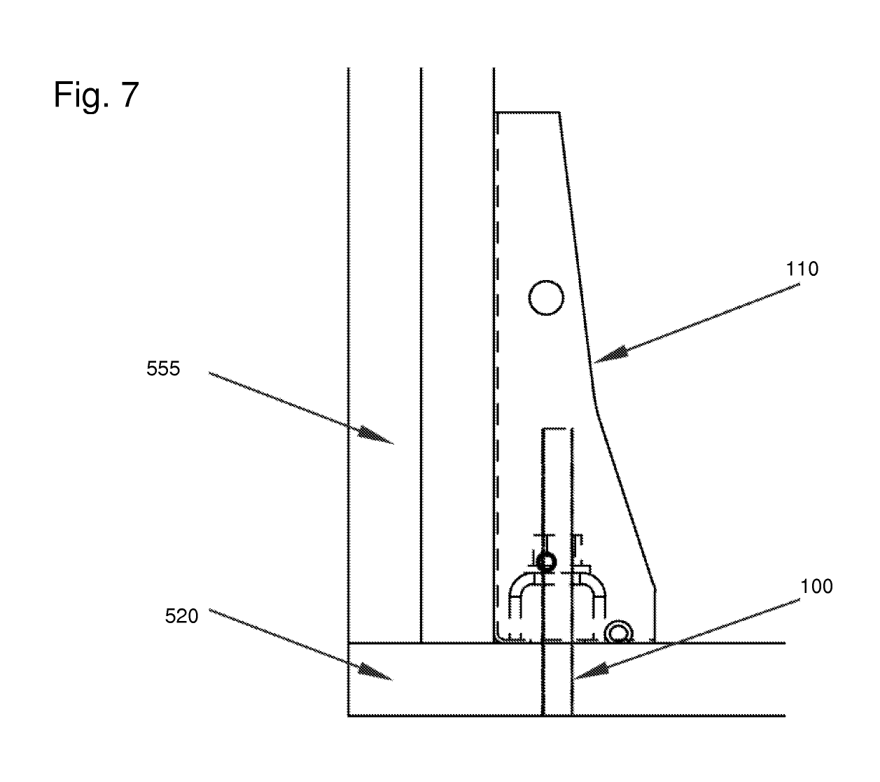

FIG. 7 depicts a threaded rod 100 penetrating a sill plate 520 and entering into a hold down unit 110. The hold down unit is shown to support one or more wall studs 555, as further shown in FIG. 9.

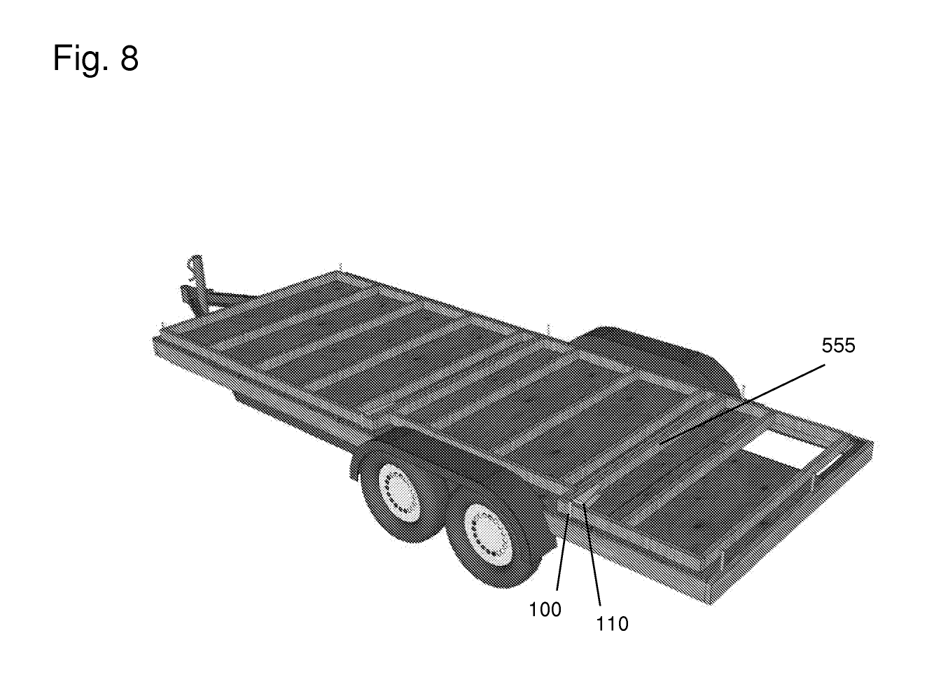

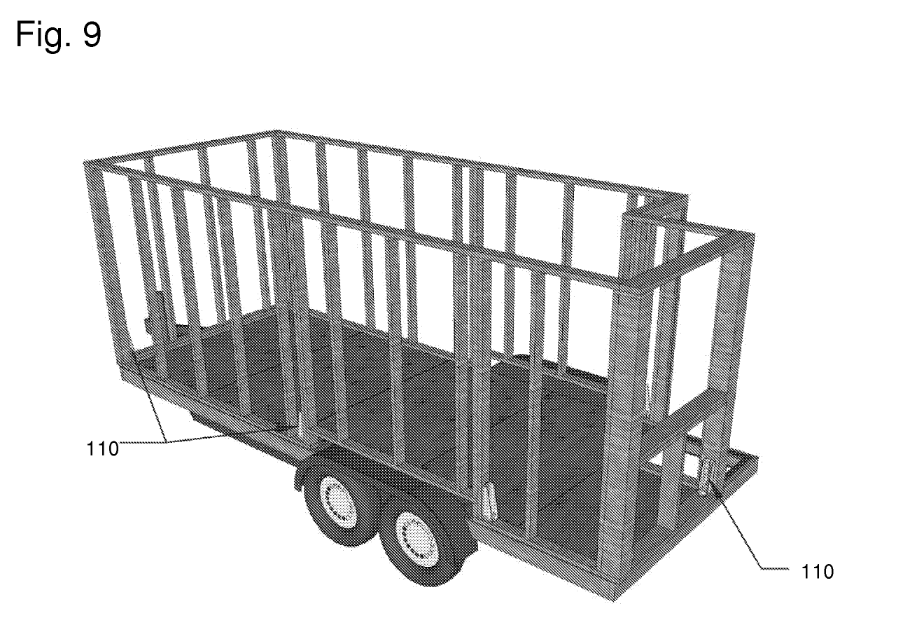

FIG. 8 depicts a wall studs fabricated upon the subfloor of a trailer. The wall studs are attached to a hold down unit, but the threaded rods 100 are not yet inserted into the hold down units.

FIG. 9 depicts hold down units 110 attached to studs and threaded rods.

Disclosed embodiments include the following items:

1. A trailer for securing and transporting a structure, the trailer comprising:

a) two parallel main deck frame members, with each main deck frame member comprising a top surface, a bottom surface, an inside vertical surface, an outside vertical surface, a front end and a back end;

b) a plurality of Z bar floor joists attached between the two parallel main deck frame members at the inside vertical surfaces of the main deck frame members, with each Z bar floor joist comprising an upper horizontal section attached to a vertical section, with the vertical section attached to a lower horizontal section;

c) a front deck frame member attached to the two front ends of the main deck frame members;

d) a rear deck frame member attached to the two back ends of the main deck frame members;

e) a lower pan attached to a bottom surface of the lower horizontal sections of the plurality of Z bar floor joists; and

f) a plurality of threaded rods attached to the outside vertical surfaces of the two main deck frame members.

2. The trailer of 1 further comprising a plurality of porch joists attached to the rear deck frame member 220 and a Z bar floor joist.

3. The trailer of 2 further comprising insulation attached to the vertical walls and inside surfaces of the upper and lower horizontal sections of the Z bar floor joist.

4. The trailer of 3 further comprising fascia board attached to the outside vertical surfaces of the two main deck frame members and to the plurality of threaded rods.

5. The trailer of 6 further comprising a subfloor attached to a top surface of the fascia board and to upper top surfaces of the upper horizontal sections of the plurality of Z bar floor joists.

6. The trailer of 5 further comprising a sill plate disposed upon the subfloor and disposed over the plurality of threaded rods.

7. The trailer of 6 further comprising a plurality hold down units disposed over the plurality of threaded rods with nuts fastened upon the threaded rods to secure the plurality of hold down units.

8. The trailer of 7 further comprising a wall stud attached to each of the plurality of hold down units.

What is claimed is:

1. A trailer for securing and transporting a structure, the trailer comprising:
a) two parallel main deck frame members, with each main deck frame member comprising a top surface, a bottom surface, an inside vertical surface, an outside vertical surface, a front end and a back end;
b) a plurality of Z bar floor joists attached between the two parallel main deck frame members at the inside vertical surfaces of the main deck frame members, with each Z bar floor joist comprising an upper horizontal section attached to a vertical section, with the vertical section attached to a lower horizontal section;
c) a front deck frame member attached to the two front ends of the main deck frame members;
d) a rear deck frame member attached to the two back ends of the main deck frame members;
e) a lower pan attached to a bottom surface of the lower horizontal sections of the plurality of Z bar floor joists; and
f) a plurality of threaded rods attached to the outside vertical surfaces of the two main deck frame members.

2. The trailer of claim 1 further comprising a plurality of porch joists attached to the rear deck frame member and a Z bar floor joist.

3. The trailer of claim 2 further comprising insulation attached to the vertical walls and inside surfaces of the upper and lower horizontal sections of the Z bar floor joist.

4. The trailer of claim 3 further comprising fascia board attached to the outside vertical surfaces of the two main deck frame members and to the plurality of threaded rods.

5. The trailer of claim 4 further comprising a subfloor attached to a top surface of the fascia board and to upper top surfaces of the upper horizontal sections of the plurality of Z bar floor joists.

6. The trailer of claim 5 further comprising a sill plate disposed upon the subfloor and disposed over the plurality of threaded rods.

7. The trailer of claim 6 further comprising a plurality hold down units disposed over the plurality of threaded rods with nuts fastened upon the threaded rods to secure the plurality of hold down units.

8. The trailer of claim 7 further comprising a wall stud attached to each of the plurality of hold down units.
